(19) United States
(12) Patent Application Publication
(10) Pub. No.: US 2024/0159425 A1
(43) Pub. Date: May 16, 2024

(54) Vent Register

(71) Applicant: Global IP Holdings, LLC, Sterling Heights, MI (US)

(72) Inventors: Hyunkyu Kim, LaSalle (CA); Scott Munro, Attica, MI (US); Manpreet Sangha, Canton, MI (US)

(73) Assignee: Global IP Holdings, LLC, Sterling Heights, MI (US)

(21) Appl. No.: 17/988,313

(22) Filed: Nov. 16, 2022

(51) Int. Cl. F24F 13/14; B60H 1/00; B60H 1/34; F24F 13/06

(52) U.S. Cl. CPC F24F 13/1413; B60H 1/00871; B60H 1/3428; F24F 13/06

(57) ABSTRACT

A vent register includes a control vane, top and bottom lazy vanes, and a cam having an opening and top and bottom slots. The control vane includes a pin slidingly received in the opening and is actuatable to pivot upward and generate a force acting on the cam thereby causing the cam to pivot to a tilted-down position and pivot downward and generate a force acting on the cam thereby causing the cam to pivot to a tilted-up position. The top vane includes a pin slidingly received in the top slot and is actuated by the cam pivoting to the tilted-down position to pivot upward whereby the top vane pivots with the control vane. The bottom vane includes a pin slidingly received in the bottom slot and is actuated by the cam pivoting to the tilted-up position to pivot downward whereby the bottom vane pivots downward with the control vane.

### TECHNICAL FIELD

The present invention relates to a vent register to be used at an air outlet for air blow adjustment.

### BACKGROUND

A “register” is an adjustable device, such as an adjustable plate, for widening and narrowing an opening and regulating a draft. A “vent” is an opening that allows air to pass out of or into a confined space. As such, a “vent register” is operable for air blow adjustment at an air outlet.

A vent register for HVAC (heating, ventilation, and air conditioning) air blow adjustment of vehicle cabins may include a front set of horizontally extending vanes (louvers or fins) and a rear set of vertically extending vanes. The horizontal vanes are pivotably (i.e., rotatably) movable vertically upward and downward and the vertical vanes are pivotably movable horizontally rightward and leftward. The air blowing direction is adjusted upward/downward by adjusting the vertical positioning of the horizontal vanes and is adjusted rightward/leftward by adjusting the horizontal positioning of the vertical vanes.

A “slim” or “thin” vent register is a vent register for use with a narrow and long (e.g., rectangular-shaped) air outlet. Styling and design considerations often lead to a vehicle incorporating vent registers in the vehicle cabin dashboard to have a high aspect ratio. In other words, those vent registers are wider than they are tall (i.e., the narrow and long air outlet is “slim” or “thin”). Such vent registers tend to produce or discharge a relatively wide air plume. Due to the narrowness of a slim air outlet, the front set of horizontal vanes of a corresponding slim vent register has a limited number of horizontal vanes.

### SUMMARY

A vent register including a cam and a plurality of vanes is provided. The plurality of vanes, such as horizontally extending vanes, includes a control vane, a top lazy vane, and a bottom lazy vane. The cam is pivotable to a tilted-up position and a tilted-down position. The cam includes a linear opening, a top arcuate slot, and a bottom arcuate slot. The control vane includes a pin portion slidingly received in the linear opening and is pivotable upward and downward. The control vane is actuatable by an operator to pivot upward and generate a first force acting on the cam thereby causing the cam to pivot to the tilted-down position and the control vane is actuatable by an operator to pivot downward and generate a second force acting on the cam thereby causing the cam to pivot to the tilted-up position. The top lazy vane includes a pin portion slidingly received in the top arcuate slot and is pivotable upward. The top lazy vane is actuated by the cam pivoting to the tilted-down position to pivot upward whereby the top lazy vane pivots upward in response to the control vane pivoting upward. The bottom lazy vane includes a pin portion slidingly received in the bottom arcuate slot and is pivotable downward. The bottom lazy vane is actuated by the cam pivoting to the tilted-up position to pivot downward whereby the bottom lazy vane pivots downward in response to the control vane pivoting downward.

The top lazy vane may be pivotable downward. In this case, the top lazy vane is actuated by the cam pivoting to the tilted-up position to pivot downward whereby the top lazy vane pivots downward in response to the control vane pivoting downward.

The bottom lazy vane may be pivotable upward. In this case, the bottom lazy vane is actuated by the cam pivoting to the tilted-down position to pivot upward whereby the bottom lazy vane pivots upward in response to the control vane pivoting upward.

A control tab may be attached to the control vane. The control tab may be actuated by an operator for the operator to actuate the control to pivot upward and to pivot downward.

The top arcuate slot and the bottom arcuate slot may have different configurations. The top arcuate slot may be configured such that the top lazy vane ceases to pivot upward in response to the control vane pivoting upward once the top lazy vane has pivoted upward to a certain point. The bottom arcuate slot may be configured such that the bottom lazy vane ceases to pivot downward in response to the control vane pivoting downward once the bottom lazy vane has pivoted downward to a certain point.

The cam may be pivotable from a non-tilted position to the tilted-up position and to the tilted-down position. The control vane, the top lazy vane, and the bottom lazy vane are each unpivoted when the cam in the non-tilted position.

A vent register having a pivotable cam, a first vane, and a second vane is also provided. The first vane includes a pin portion slidingly attached to the cam and a pin portion pivotably affixed to a first stationary point whereby the first vane is rotatable about the first stationary point. The first vane is actuatable to rotate in a first direction about the first stationary point and generate a force acting on the cam thereby causing the cam to pivot in an opposite second direction. The second vane includes a pin portion slidingly attached to the cam and a pin portion pivotably affixed to a second stationary point whereby the second vane is rotatable about the second stationary point. The second vane is actuated by the cam pivoting in the second direction to rotate in the first direction about the second stationary point whereby the second vane rotates in the first direction in response to the first vane rotating in the first direction.

The first vane may be further actuatable to rotate in the second direction about the first stationary point and generate a second force acting on the cam thereby causing the cam to pivot in the first direction. In this case, the second vane is actuated by the cam pivoting in the first direction to rotate in the second direction about the second stationary point whereby the second vane rotates in the second direction in response to the first vane rotating in the second direction.

In embodiments, the first vane rotates in the first direction about the first stationary point to be aimed either upward whereby the second vane rotates to be aimed upward in response to the first vane being aimed upward or downward whereby the second vane rotates to be aimed downward in response to the first vane being aimed downward.

The vent assembly may further include a third vane having a pin portion slidingly attached to the cam and a pin portion pivotably affixed to a third stationary point whereby the third vane is rotatable about the third stationary point. The third vane is actuated by the cam pivoting in the second direction to rotate in the first direction about the third stationary point whereby the third vane rotates in the first direction in response to the first vane rotating in the first direction.

### BRIEF DESCRIPTION OF THE DRAWINGS

FIG. 1A illustrates a perspective view of a vent register;

FIG. 1B illustrates a top plan, schematic, partially broken away view of the vent register;

FIG. 2A illustrates a cutaway perspective view of the vent register showing horizontal vanes, vertical vanes, and a cam assembly of the vent register;

FIG. 2B illustrates an enlarged view of the circled area 2A of FIG. 2A;

FIG. 3A illustrates a perspective view of the horizontal vanes and the cam assembly in an aiming straight position;

FIG. 3B illustrates a perspective view of the horizontal vanes and the cam assembly in an aiming up position;

FIG. 3C illustrates a perspective view of the horizontal vanes and the cam assembly in an aiming down position;

FIG. 4A illustrates a side schematic view of the horizontal vanes and the cam assembly in the aiming straight position;

FIG. 4B illustrates a side schematic view of the horizontal vanes and the cam assembly in the aiming up position;

FIG. 4C illustrates a side schematic view of the horizontal vanes and the cam assembly in the aiming down position;

FIG. 5 illustrates an exploded view of the vent register;

FIG. 6A illustrates a first angled perspective view of the vent register; and

FIG. 6B illustrates a second angled perspective view of the vent register.

### DETAILED DESCRIPTION

Detailed embodiments of the present invention are disclosed herein; however, it is to be understood that the disclosed embodiments are merely exemplary of the present invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

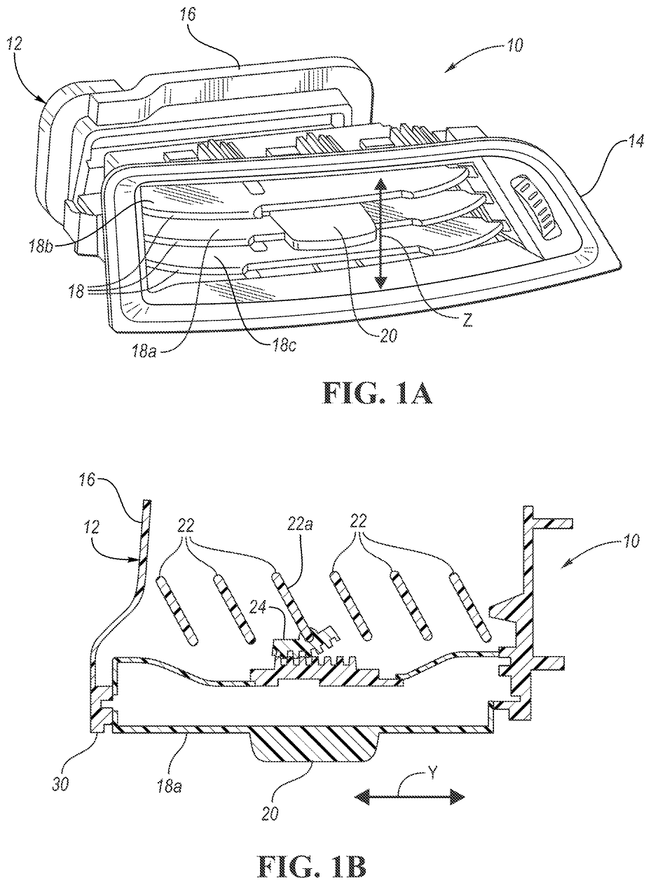

Referring now to FIGS. 1A and 1B, a perspective view and a top plan, schematic, partially broken away view of a vent register 10 are respectively shown. Vent register 10 includes a housing 12 (not shown in its entirety) having a faceplate 14 and a body 16. Housing 12 is typically configured and dimensioned for insertion into and attachment to a cooperating aperture in a vehicle component such as a dash panel, door trim panel, roof trim panel, center console, etc. Housing 12 is typically positioned at a terminal end (i.e., an air outlet) of a vehicle HVAC duct whereby the duct is in fluid communication with the housing interior such that air from the HVAC passes through the housing and therefrom through faceplate 14 and into the vehicle passenger cabin.

Vent register 10 further includes a set of horizontally extending vanes 18. Horizontal vanes 18 are located at faceplate 14. As such, the set of horizontal vanes 18 is a “front” set of vanes. Horizontal vanes 18 are pivotably (i.e., rotatably) movable vertically upward and downward along a vertical “Z”-axis of the vehicle. Horizontal vanes 18 are pivotably adjusted vertically upward/downward to adjust the air blowing direction of vent register 10 upward/downward and thereby direct a flow of air from the HVAC through vent register 100 and into the passenger cabin.

Vent register 10 is a “slim” vent register. Consequently, the set of horizontally extending vanes 18 has only three horizontal vanes. Namely, the set of horizontal vanes 18 includes a primary vane 18a, a top vane 18b, and a bottom vane 18c. As shown in FIG. 1A, primary vane 18a is located vertically between top vane 18b and bottom vane 18c; top vane 18b is located vertically above primary vane 18a; and bottom vane 18c is located vertically below primary vane 18a.

Horizontal vanes 18 are pivotably movable vertically upward and downward all together as a group or as sub-groups. For instance, in one embodiment, primary vane 18a, top vane 18b, and bottom vane 18c together are pivotably movable vertically upward and downward; in another embodiment, primary vane 18a and top vane 18b together without bottom vane 18c are pivotably movable vertically upward; in another embodiment, primary vane 18a and bottom vane 18c together without top vane 18b are pivotably movable vertically downward. In this regard, vent register 10 further includes a cam assembly 30. As described below, cam assembly 30 itself is pivotable between tilted-up and tilted-down positions and horizontal vanes 18 are slidingly attached to cam assembly 30 to be pivotably movable vertically upward and downward. Cam assembly 30 has different configurations in the different embodiments to cause horizontal vanes 18 to be pivotably movable vertically upward and downward all together as a group or as sub-groups.

Vent register 10 further includes a control tab 20 carried on primary vane 18a. Control tab 20 may be tilted upward and downward by an operator to pivotably move primary vane 18a upward and downward. Primary vane 18a pivotably moving upward causes, via cam assembly 30, top vane 18b to pivotably move upward. In embodiments, primary vane 18a pivotably moving upward also causes, via cam assembly 30, bottom vane 18c to pivotably move upward. Likewise, primary vane 18a pivotably moving downward causes, via cam assembly 30, bottom vane 18c to pivotably move downward. In embodiments, primary vane 18a pivotably moving downward also causes, via cam assembly 30, top vane 18b to pivotably move downward.

In this way, the air plume outputted through faceplate 14 and into the vehicle passenger cabin may be adjusted along an angle with respect to the vertical Z-axis.

Although horizontal vanes 18 may be pivotably movable vertically upward and downward together as a group or as sub-groups, only primary vane 18a is configured to be directly adjusted through the tilting of control tab 20 by an operator to pivotably move upward and downward. Via cam assembly 30, pivotable movement of primary vane 18a upward causes pivotable upward movement of at least top vane 18b and pivotable movement of primary vane 18a downward causes pivotable downward movement of at least bottom vane 18c. As such, top vane 18b and bottom vane 18c are “lazy” vanes as their pivoting is in response to primary vane 18a pivoting. Further, primary vane 18a is a “control” vane as its pivoting causes top and bottom lazy vanes 18b and 18c to pivot.

Further, via cam assembly 30, the upward/downward pivoting (i.e., rotating) of top and bottom lazy vanes 18b and 18c with the upward/downward pivoting of primary vane 18a is limited to a predetermined amount. For example, the pivoting of top and bottom lazy vanes 18b and 18c is limited to 60% of the pivoting range of primary vane 18a. As such, top and bottom lazy vanes 18b and 18c pivot (rotate) with primary vane 18a through the initial 60% of the pivoting range of the primary vane. Top and bottom lazy vanes 18b and 18c do not further pivot as primary vane 18a further pivots beyond the initial 60% of the pivoting range.

Vent register 10 further includes a set of vertically extending vanes 18. Vertical vanes 22 are located within the interior of housing 12. As such, the set of vertical vanes 22 is a “rear” set of vanes. Vertical vanes 22 are pivotably (i.e., rotatably) movable horizontally rightward and leftward along a horizontal “Y”-axis of the vehicle. Vertical vanes 22 are pivotably adjusted horizontally rightward/leftward to adjust the air blowing direction of vent register 10 rightward/leftward and thereby direct a flow of air from the HVAC through vent register 100 and into the passenger cabin.

Vertical vanes 22 are pivotably movable horizontally rightward and leftward as a group. In this regard, control tab 20 is connected by a gear set 24 to a given vertical vane 22a. Control tab 20 may be shifted rightward and leftward by an operator to pivotably move vertical vane 22a rightward and leftward. Vertical vanes 22 are connected to one another whereby given vertical vane 22a pivotably moving rightward/leftward causes the remaining vertical vanes 22 to correspondingly pivotably move rightward/leftward. In this way, the air plume outputted through faceplate 14 and into the vehicle passenger cabin may be adjusted along an angle with respect to the horizontal Y-axis.

Vent register 10 may further include other elements that are movable relative to each other to enable an operator to direct the flow of air as the operator desires.

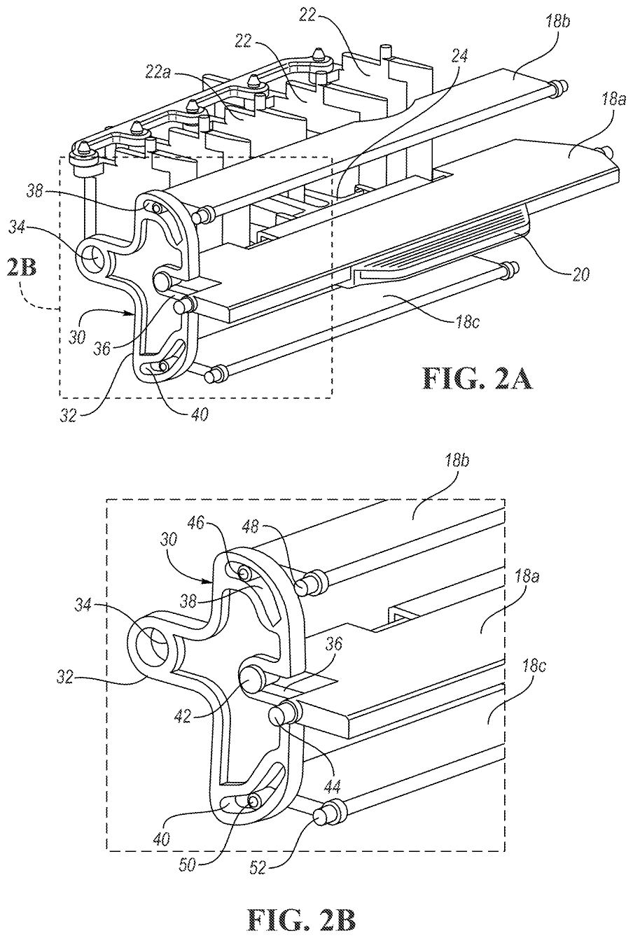

Referring now to FIGS. 2A and 2B, with continual reference to FIGS. 1A and 1B, vent register 10 will further be described. FIG. 2A illustrates a cutaway perspective view of vent register 10 with housing 12 removed therefrom. FIG. 2B illustrates an enlarged view of the circled area 2A of FIG. 2A.

Horizontal vanes 18, vertical vanes 22, and cam assembly 30 of vent register 10 are shown in FIG. 2A. As indicated, via cam assembly 30, pivotable movement of primary vane 18a upward/downward causes pivotable upward/downward movement of top lazy vane 18b and/or bottom lazy vane 18c.

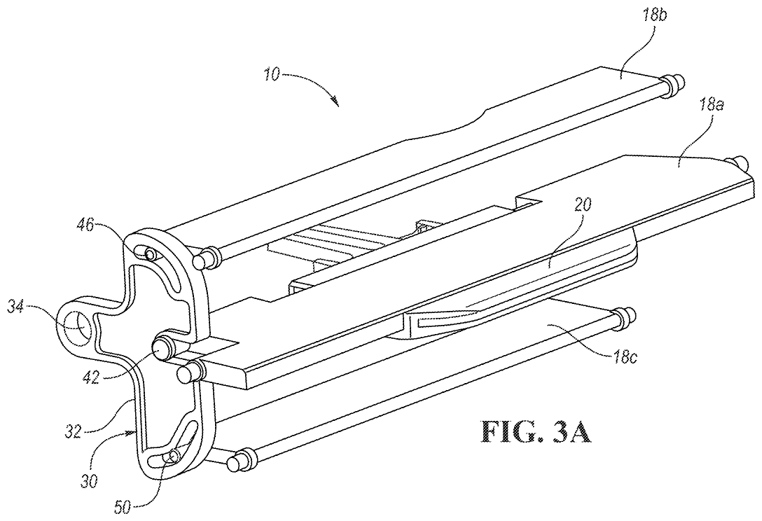

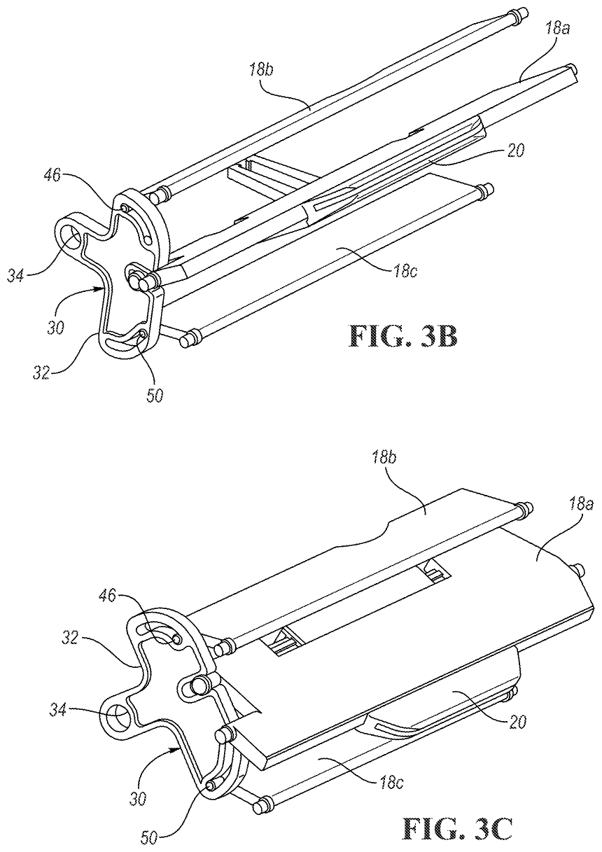

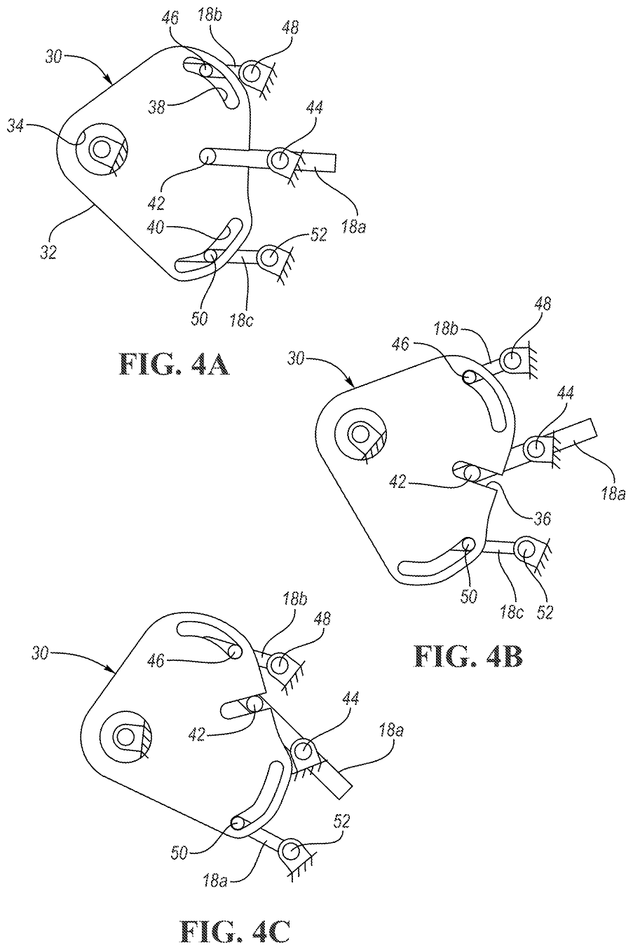

Cam assembly 30 includes a cam 32. Cam 32 is pivotably (i.e., rotatably) movable upward and downward. In this regard, cam 32 includes a pivot portion 34 about which cam 32 is pivotable. Pivot portion 34 of cam 32 is pivotably affixed to housing 12 (not shown) to enable the cam to pivot (i.e., rotate) between a non-tilted position (shown in FIGS. 3A and 4A), a tilted-down position (shown in FIGS. 3B and 4B), and a tilted-up position (shown in FIGS. 3C and 4C). A downward force from primary vane 18a acting on cam 32 causes the cam to pivot downward about pivot portion 34 towards the tilted-down position. An upward force from primary vane 18a acting on cam 32 causes the cam to pivot upward about pivot portion 34 towards the tilted-up position.

Horizontal vanes 18 are each slidingly attached to cam 32 to be pivotably movable upward and downward. In this regard, cam 32 further includes a central linear opening 36, a top arcuate slot 38, and a bottom arcuate slot 40. Central opening 36 is generally vertically aligned with pivot portion 34 and generally centered between top and bottom slots 38 and 40. Top and bottom slots 38 and 40 are generally geometrically opposed from one another. In the illustrated embodiments, top slot 38 and bottom slot 40 of cam 32 have similar but different configurations.

Further in this regard, primary vane 18a includes spaced apart first and second pin portions 42 and 44. First pin portion 42 is slidingly received in central opening 36 of cam 32 and second pin portion 44 is pivotably affixed to housing 12 (not shown) whereby primary vane 18a including first pin portion 42 is rotatable about second pin portion 44. Top lazy vane 18b includes spaced apart first and second pin portions 46 and 48. First pin portion 46 is slidingly received in top slot 38 of cam 32 and second pin portion 48 is pivotably affixed to housing 12 (not shown) whereby top lazy vane 18b including first pin portion 46 is rotatable about second pin portion 48. Bottom lazy vane 18c includes spaced apart first and second pin portions 50 and 52. First pin portion 50 is slidingly received in bottom slot 40 of cam 32 and second pin portion 52 is pivotably affixed to housing 12 (not shown) whereby bottom lazy vane 18c including first pin portion 50 is rotatable about second pin portion 52.

Referring now to FIGS. 3A, 3B, 3C, 4A, 4B, and 4C, with continual reference to FIGS. 2A and 2B, horizontal vanes 18 and cam assembly 30 in an aiming straight position, in an aiming up position, and an in aiming down position will be described. FIGS. 3A and 4A illustrate a perspective view and a side schematic view, respectively, of horizontal vanes 18 and cam assembly 30 in the aiming straight position. FIGS. 3B and 4B illustrate a perspective view and a side schematic view, respectively, of horizontal vanes 18 and cam assembly 30 in the aiming up position. FIGS. 3C and 4C illustrate a perspective view and a side schematic view, respectively, of horizontal vanes 18 and cam assembly 30 in the aiming down position.

Primary vane 18a is rotatable about its second pin portion 44 in a first direction (e.g., counterclockwise in the illustrated embodiments) to be pivotably moved upward, shown in FIGS. 3B and 4B, and in an opposite second direction (e.g., clockwise) to be pivotably moved downward, shown in FIGS. 3C and 4C. Top lazy vane 18b is rotatable about its second pin portion 48 in the first direction to be pivotably moved upward, shown in FIGS. 3B and 4B, and in the second direction to be pivotably moved downward, shown in FIGS. 3C and 4C. Bottom lazy vane 18c is rotatable about its second pin portion 52 in the second direction to be pivotably moved downward, shown in FIGS. 3C and 4C. Bottom lazy vane 18c is also rotatable about its first pin portion 50 in the first direction, but bottom lazy vane 18c does not rotate or at least rotates only a small amount in the first direction in the illustrated embodiments.

As noted, in the illustrated embodiments, top slot 38 and bottom slot 40 of cam 32 have similar but different configurations. Consequently, pivotal upward/downward movement of primary vane 18a does not cause the same pivotal upward/downward movement of top and bottom lazy vanes 18b and 18c. In particular, the configurations of top slot 38 and bottom slot 40 of cam 32 are designed such that (i) primary vane 18b pivotably moving upward causes, via cam assembly 30, top lazy vane 18b to pivotably move upward with roughly no pivotably upward movement of bottom lazy vane 18c, shown in FIGS. 3B and 4B, and (ii) primary vane 18b pivotably moving downward causes, via cam assembly 30, bottom lazy vane 18c to pivotably move downward with some pivotal downward movement of top lazy vane 18a, shown in FIGS. 3C and 4C.

As further noted, in the illustrated embodiments, the pivoting of top and bottom lazy vanes 18b and 18c is limited to a predetermined amount of the pivoting range of primary vane 18a.

In the aiming straight position shown in FIGS. 3A and 4A, horizontal vanes 18 are all oriented to point straight along a level height. Further, cam 32 is in its non-tilted position. As each horizontal vane 18 points straight along a level height, first and second pins portions 42, 44; 46, 48; and 50, 52 of horizontal vanes 18a, 18b, and 18c, respectively, are generally at the same height with one another. As cam 32 is in its non-tilted position, first pin portions 46 and 50 of horizontal vanes 18b and 18C are respectively positioned in middle parts of top and bottom slots 38 and 40 of cam 32.

The aiming up position shown in FIGS. 3B and 4B is achieved in response to a downward force of primary vane 18 acting on cam 32. The downward force acting on cam 32 is applied at the engagement between first pin portion 42 of primary vane 18a and central opening 36 of cam 32. As described, an operator actuates primary vane 18a via control tab 20 to cause primary vane 18a to rotate in the first direction about its second pin portion 44 for the primary vane to generate the downward force on cam 32. In this regard, the operator pushes control tab 20 upward.

In the aiming up position, primary vane 18a and top lazy vane 18b are oriented to point upward. Further, cam 32 is in its tilted-down position and bottom lazy vane 18c is generally oriented to point straight along a level height. As primary vane 18a is oriented to point upward, its first pin portion 42 is positioned at a height below its second pin portion 44. Likewise, as top lazy vane 18b is oriented to point upward, its first pin portion 46 is positioned at a height below its second pin portion 48. As cam 32 is tilted downward, first pin portion 46 is positioned at a top part of top slot 38 of cam 32. As cam 32 is tilted downward and due to the configuration of bottom slot 40 of cam 32, bottom lazy vane 18c generally points straight along a level height with its first and second pin portions 50 and 52 being at the same height and with its first pin portion 50 being positioned at a top part of bottom slot 40 of cam 32.

The aiming down position shown in FIGS. 3C and 4C is achieved in response to an upward force of primary vane 18 acting on cam 32. The upward force acting on cam 32 is applied at the engagement between first pin portion 42 of primary vane 18a and central opening 36 of cam 32. As described, an operator actuates primary vane 18a via control tab 20 to cause primary vane 18a to rotate in the second direction about its second pin portion 44 for the primary vane to generate the upward force on cam 32. In this regard, the operator pushes control tab 20 downward.

In the aiming down position, primary vane 18a and bottom lazy vane 18c are oriented to point downward. Further, cam 32 is in its tilted-up position and top lazy vane 18c is oriented to slightly point downward. As primary vane 18a is oriented to point downward, its first pin portion 42 is positioned at a height above its second pin portion 44. Likewise, as bottom lazy vane 18c is oriented to point downward, its first pin portion 50 is positioned at a height above its second pin portion 52. As cam 32 is tilted upward, first pin portion 50 is positioned at a bottom part of bottom slot 40 of cam 32. As cam 32 is tilted upward and due to the configuration of top slot 38 of cam 32, top lazy vane 18b points slightly downward with its first pin portion 46 being slightly higher than its second pin portion 48 and with its first pin portion 46 being positioned at a bottom portion of top slot 38 of cam 32.

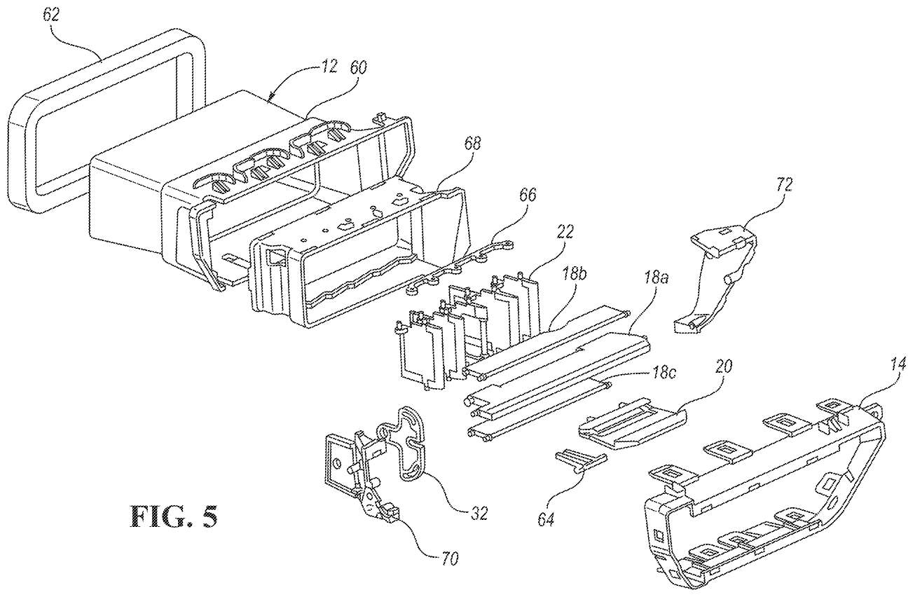

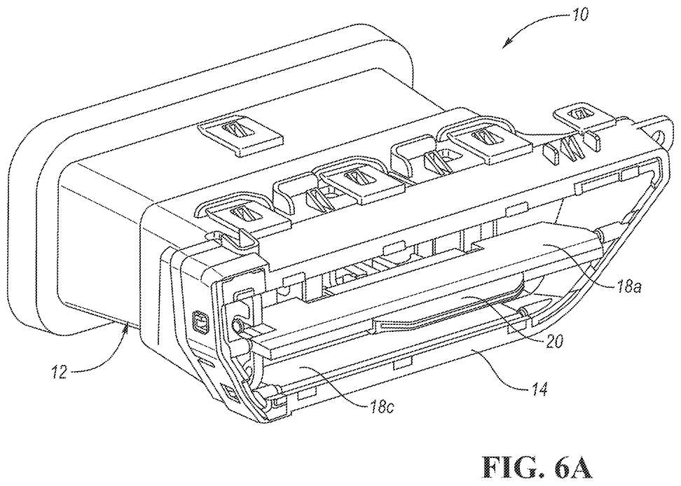

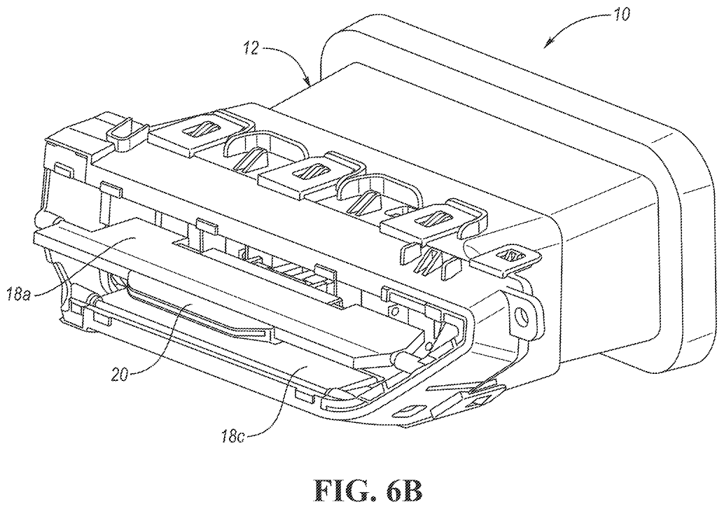

Referring now to FIGS. 5, 6A, and 6B, with continual reference to the preceding drawings, vent register 10 will be further described. FIG. 5 illustrates an exploded view of vent register 10. FIGS. 6A and 6B illustrate first and second angled perspective views, respectively, of vent register 10.

As shown in FIG. 5, housing 12 includes, in addition to faceplate 14, an outlet housing body 60. As shown and as described, outlet housing body 60 has an interior in which other components of vent register 10 are placed. A foam seal 62 is provided for extending around the periphery of the rear end of outlet housing body 60 for sealing vent register 10 such as to an HVAC duct. Faceplate 14 is attachable to the front end of outlet housing body 60. As shown and as described, faceplate 14 functions as a retainer and a bezel for vent register 10.

As further shown in FIG. 5, control tab 20 is in the form of a slider knob. Control tab 20 is to be carried on primary vane 18a. Control tab 20 has an associated slider fork 64. Slider fork 64 is connectable to the given vertical vane 22a. Control tab 20 being shifted rightward and leftward by an operator causes slider fork 64 to be shifted rightward and leftward thereby causing the given vertical vane 22a to pivotably move rightward and leftward. A connector link 66 is provided for connecting vertical vanes 22 including the given vertical vane 22a together. Consequently, the given vertical vane 22a being pivotably moved rightward/leftward causes the remaining vertical vanes 22 to correspondingly pivotably move rightward/leftward. Vertical vanes 22, connected by connector link 66, are to be operably mounted within a retainer 68.

Horizontal vanes 18 (namely, primary vane 18a, top lazy vane 18b, and bottom lazy vane 18c) are pivotably attachable to cam 32. As described, first pin portions 42, 46, and 50 of primary vane 18a, top lazy vane 18b, and bottom lazy vane 18c are slidingly received in central opening 36, top arcuate slot 38, and bottom arcuate slot 40, respectively, for the horizontal vanes to be slidingly attached to cam 32.

Cam assembly 30 further includes a first retainer 70 and a second retainer 72. First retainer 70 and second retainer 72 are respectively positioned adjacent left-hand and right-hand sides of horizontal vanes 18. First retainer 70 and second retainer 72 are to be operably mounted to outlet housing 60 to thereby be fixed in place.

Pivot portion 34 of cam 32 is pivotably attachable to first retainer 70. Cam 32 is thereby pivotable (rotatable) between the non-tilted position, the tilted-up position, and the tilted-down position. Second pin portions 44, 48, and 52 of primary vane 18a, top lazy vane 18b, and bottom lazy vane 18c are pivotably attachable to first retainer 70. Second pin portions 44, 48, and 52, and likewise first pin portions 42, 46, and 50, are located on the left-hand side of horizontal vanes 18. A second set of second pin portions (not designated with reference numbers) located on the right-hand side of horizontal vanes 18 are pivotably attachable to second retainer 72. Via the pivotable attachment of the pairs of second pin portions on the left-hand side and right-hand side of horizontal vanes 18, the horizontal vanes are respectively pivotable (rotatable) about the second pin portions.

As described, a vent register in accordance with embodiments of the present invention includes a lazy vane cam for slim outlet. The vent register may be for vehicle applications as well as for residential applications. The vent register is intended to overcome problems unresolved by previous technology which include full rotation of each vane not being possible within a tight package and which include failure of the vanes with a standard lazy vane linkage.

The lazy vanes of the vent register are controllable via a cam so that the lazy vanes do not fail or move out of position. Failed or out of position lazy vanes would inhibit to properly aim the air. Two lazy vanes (top and bottom) are provided for the vent register to have improved air flow performance. As the cam, unlike a standard linkage, does not slip out of position or allow either lazy vane to move out of position, the vent register has improved air flow performance with outputs such as plume length and aiming angles for up/down airflow. In summary, the vent register has full position control of the top and bottom lazy vanes for improved aiming and has a simplified and compact outlet design.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

What is claimed is:

1. A vent register comprising:
a pivotable cam;
a first vane including a pin portion slidingly attached to the cam and a pin portion pivotably affixed to a first stationary point whereby the first vane is rotatable about the first stationary point, the first vane being actuatable to rotate in a first direction about the first stationary point and generate a force acting on the cam thereby causing the cam to pivot in an opposite second direction; and
a second vane including a pin portion slidingly attached to the cam and a pin portion pivotably affixed to a second stationary point whereby the second vane is rotatable about the second stationary point, the second vane being actuated by the cam pivoting in the second direction to rotate in the first direction about the second stationary point whereby the second vane rotates in the first direction in response to the first vane rotating in the first direction.

2. The vent register of claim 1 wherein:
the first vane is actuatable to rotate in the second direction about the first stationary point and generate a second force acting on the cam thereby causing the cam to pivot in the first direction; and
the second vane is actuated by the cam pivoting in the first direction to rotate in the second direction about the second stationary point whereby the second vane rotates in the second direction in response to the first vane rotating in the second direction.

3. The vent register of claim 1 wherein:
the first vane rotates in the first direction about the first stationary point to be aimed upward whereby the second vane rotates to be aimed upward in response to the first vane being aimed upward.

4. The vent register of claim 1 wherein:
the first vane rotates in the first direction about the first stationary point to be aimed downward whereby the second vane rotates to be aimed downward in response to the first vane being aimed downward.

5. The vent register of claim 1 further comprising:
a third vane including a pin portion slidingly attached to the cam and a pin portion pivotably affixed to a third stationary point whereby the third vane is rotatable about the third stationary point, the third vane being actuated by the cam pivoting in the second direction to rotate in the first direction about the third stationary point whereby the third vane rotates in the first direction in response to the first vane rotating in the first direction.

6. The vent register of claim 5 wherein:
the first vane is positioned between the second vane and the third vane.

7. The vent register of claim 1 wherein:
the first vane is actuatable to rotate in the second direction about the first stationary point and generate a second force acting on the cam thereby causing the cam to pivot in the first direction; and
the vent register further comprising a third vane including a pin portion slidingly attached to the cam and a pin portion pivotably affixed to a third stationary point whereby the third vane is rotatable about the third stationary point, the third vane being actuated by the cam pivoting in the first direction to rotate in the second direction about the third stationary point whereby the third vane rotates in the second direction in response to the first vane rotating in the second direction.

8. The vent register of claim 1 wherein:
the first vane and the second vane are horizontally extending vanes.

9. The vent register of claim 1 further comprising:
a control tab attached to the first vane; and
the control tab being actuatable by an operator for the operator to actuate the first vane to rotate in the first direction about the first stationary point.

10. The vent register of claim 1 wherein:
the second vane is a lazy vane as the second vane rotates in response to the first vane rotating.

11. The vent register of claim 1 wherein:
the cam includes a pivot portion pivotably affixed to a third stationary point for the cam to be pivotable.

12. The vent register of claim 1 wherein:
the cam includes a linear opening and an arcuate slot;
the pin portion of the first vane slidingly attached to the cam is received in the linear opening; and
the pin portion of the second vane slidingly attached to the cam is received in the arcuate slot.

13. A vent register comprising:
a cam pivotable to a tilted-up position and a tilted-down position, the cam including a linear opening, a top arcuate slot, and a bottom arcuate slot;
a control vane including a pin portion slidingly received in the linear opening and being pivotable upward and downward, the control vane being actuatable by an operator to pivot upward and generate a first force acting on the cam thereby causing the cam to pivot to the tilted-down position and the control vane being actuatable by an operator to pivot downward and generate a second force acting on the cam thereby causing the cam to pivot to the tilted-up position;
a top lazy vane including a pin portion slidingly received in the top arcuate slot and being pivotable upward, the top lazy vane being actuated by the cam pivoting to the tilted-down position to pivot upward whereby the top lazy vane pivots upward in response to the control vane pivoting upward; and
a bottom lazy vane including a pin portion slidingly received in the bottom arcuate slot and being pivotable downward, the bottom lazy vane being actuated by the cam pivoting to the tilted-up position to pivot downward whereby the bottom lazy vane pivots downward in response to the control vane pivoting downward.

14. The vent register of claim 13 wherein:
the top lazy vane is pivotable downward and is actuated by the cam pivoting to the tilted-up position to pivot downward whereby the top lazy vane pivots downward in response to the control vane pivoting downward.

15. The vent register of claim 13 wherein:
the bottom lazy vane is pivotable upward and is actuated by the cam pivoting to the tilted-down position to pivot upward whereby the bottom lazy vane pivots upward in response to the control vane pivoting upward.

16. The vent register of claim 13 further comprising:
a control tab attached to the control vane; and
the control tab being actuatable by an operator for the operator to actuate the control to pivot upward and to pivot downward.

17. The vent register of claim 13 wherein:
the top arcuate slot and the bottom arcuate slot have different configurations.

18. The vent register of claim 13 wherein:
the top arcuate slot is configured such that the top lazy vane ceases to pivot upward in response to the control vane pivoting upward once the top lazy vane has pivoted upward to a certain point.

19. The vent register of claim 13 wherein:
the bottom arcuate slot is configured such that the bottom lazy vane ceases to pivot downward in response to the control vane pivoting downward once the bottom lazy vane has pivoted downward to a certain point.

20. The vent register of claim 13 wherein:
the cam is pivotable from a non-tilted position to the tilted-up position and to the tilted-down position; and
the control vane, the top lazy vane, and the bottom lazy vane each being unpivoted when the cam in the non-tilted position.
